(19) United States
(12) Patent Application Publication
(10) Pub. No.: US 2016/0284374 A1
(43) Pub. Date: Sep. 29, 2016

(54) HOLOGRAPHIC STORAGE DEVICE

(71) Applicant: HITACHI, LTD., Tokyo (JP)

(72) Inventors: Kenichiro YAMADA, Tokyo (JP); Shinsuke ONOE, Tokyo (JP); Kouichirou NISHIMURA, Tokyo (JP)

(73) Assignee: Hitachi, Ltd., Tokyo (JP)

(21) Appl. No.: 15/034,998

(22) PCT Filed: Nov. 8, 2013
(86) PCT No.: PCT/JP2013/080180

§ 371 Date: May 6, 2016

(51) Int. Cl. G11B 7/0065

(52) U.S. Cl. CPC G11B 7/0065

(57) ABSTRACT

The problem addressed by the present invention is to increase the use efficiency of a holographic storage medium, achieving an increase in the number of storage layers, and to achieve favorable and stable storage maintaining the storage quality of each pixel of a page interior and page exterior. As a solution, the present invention is provided with: a phase mask that adds phase information to signal light; a phase mask drive unit that drives the phase mask; a phase mask control unit that controls the phase mask drive unit; and a phase mask drive speed detection unit that detects the drive speed of the phase mask. When the phase mask drive speed obtained by the phase mask drive speed detection unit is contained within a predetermined range, the storage of information is executed.

### TECHNICAL FIELD

The present invention relates to a device for storing information in a storage medium by using holography.

### BACKGROUND ART

A holographic storage technology is a technology for storing information in a storage medium by overlapping signal light having information of page data modulated two-dimensionally by a spatial light modulator with reference light inside the storage medium and by causing refractive-index modulation to be generated in the storage medium by an interference fringe pattern generated at that time.

In reproduction of the information, by irradiating the storage medium with the reference light used during storage, a hologram stored in the storage medium acts as if it is a diffraction grating and generates diffracted light. This diffracted light including the stored signal light and phase information is reproduced as the same light.

The reproduced signal light is detected two-dimensionally at a high speed by using a photodetector such as a CMOS and CCD. As described above, the holographic storage technology enables storage and reproduction of two-dimensional information in an optical storage medium by one hologram and moreover by overwriting a plurality of pieces of page data at a place in the storage medium, high-speed storage/reproduction of a large amount of information can be accomplished.

The light collected on the holographic storage medium during storage of the hologram has high intensity at a point at a center of a light collection spot (hereinafter referred to as an original point) and the intensity decreases as a distance from the original point increases. As described above, if the signal light concentrates on one portion of the storage medium, as described in Non-Patent Literature 1, for example, problems such as drop of use efficiency of the storage medium caused by saturation of local use of the storage medium and drop of S/N during reproduction occur. Thus, there is a method using an optical element called a phase mask for increasing uniformity of signal light intensity during storage. Ideally, the phase mask is preferably incorporated in each pixel of an SLM (spatial light modulator), but since positioning accuracy with the SLM becomes extremely difficult, the phase mask is fixedly arranged in an optical path of the signal light as in Patent Literature 1 in view of productivity. In this case, depending on a phase modulation pattern of the phase mask, a portion with high intensity locally remains and thus, Patent Literature 1 describes that this problem is avoided by driving the phase mask.

### CITATION LIST

### Patent Literature

PATENT LITERATURE 1: U.S. Pat. No. 7,813,017

### Non Patent Literature

NON-PATENT LITERATURE 1: Holographic Data Storage

### SUMMARY OF INVENTION

### Technical Problem

If a drive speed of the phase mask is too fast, diffraction efficiency of the hologram drops, and contrast is generated by interference between the signal light and the reference light, while even if the drive speed is too slow, a high-frequency noise is generated. Thus, in order to make a storage condition of each pixel inside and outside of the page equal to each other while the effect described in Patent Literature 1 is obtained, it is further preferable that the drive speed of the phase mask during storage is contained within a certain optimal speed range. However, with the driving method of the phase mask described in Patent Literature 1, this characteristic is not considered and thus, a storage quality deteriorates in the hologram stored by the driving method described in Patent Literature 1.

Thus, an object of the present invention is to realize favorable and stable storage.

### Solution to Problem

The aforementioned problem is solved by performing information storage if the phase mask drive speed is contained within a predetermined range as an example.

### Advantageous Effect of Invention

According to the present invention, favorable and stable signal storage can be realized.

### BRIEF DESCRIPTION OF DRAWINGS

FIG. 1 is a block diagram illustrating a holographic storage/reproducing device of the present invention.

FIG. 2 is a schematic view illustrating a pick-up in storage of the holographic storage/reproducing device of an embodiment 1 and an embodiment 2.

FIG. 3 is a schematic view illustrating the pick-up in reproducing of the holographic storage/reproducing device of the embodiment 1 and the embodiment 2.

FIG. 4 is a schematic view illustrating an embodiment of a phase mask of the holographic storage/reproducing device and its pattern cycle.

FIG. 5 is a schematic diagram illustrating an SNR in reproducing with respect to a drive speed of the phase mask in storage.

FIG. 6 is a flowchart of storage processing of the holographic storage/reproducing device of the present invention.

FIG. 7 is a flowchart of enable interruption processing during the storage processing of the holographic storage/reproducing device of the embodiment 1.

FIG. 8 is a schematic view illustrating a relation among the phase mask drive speed, a storage enable signal, and a page storage timing signal during the storage processing of the holographic storage/reproducing device of the embodiment 1.

FIG. 9 is a schematic view illustrating a positional trajectory of the phase mask of the holographic storage/reproducing device of the embodiment 1 in ideal time when there is no fluctuation in continuous multi-storage unit time.

FIG. 10 is a schematic view illustrating the positional trajectory of the phase mask to which the present invention is not applied in the holographic storage/reproducing device of the embodiment 1 if there is a bias in the continuous multi-storage unit.

FIG. 11 is a schematic view illustrating the positional trajectory of the phase mask to which the present invention is applied in the holographic storage/reproducing device of the embodiment 1 if there is a bias in the continuous multi-storage unit.

FIG. 12 is a schematic view illustrating a relation among the phase mask drive speed, the storage enable signal, and the page storage timing signal during the storage processing of a holographic storage/reproducing device of the embodiment 2.

FIG. 13 is a schematic view illustrating the positional trajectory of the phase mask of the holographic storage/reproducing device of the embodiment 2.

FIG. 14 is a flowchart of the enable interruption processing during the storage processing of the holographic storage/reproducing device of the embodiment 2 and an embodiment 3.

FIG. 15 is a schematic view illustrating an embodiment of the phase mask, the phase mask of the holographic storage/reproducing device, and the pattern cycle of the embodiment 3.

FIG. 16 is a schematic view illustrating a pick-up in storage of the holographic storage/reproducing device of the embodiment 3.

FIG. 17 is a schematic view illustrating a relation among the phase mask drive speed, the storage enable signal, and the page storage timing signal during the storage processing of the holographic storage/reproducing device of the embodiment 3.

FIG. 18 is a storage flowchart of the holographic storage/reproducing device when the phase mask is driven in a continuous direction of the embodiment 1.

FIG. 19 is a flowchart of the enable interruption processing during the storage processing of the holographic storage/reproducing device when the phase mask is driven in the continuous direction of the embodiment 1.

### DESCRIPTION OF EMBODIMENTS

Embodiments of the present invention will be described below by using the attached drawings.

### Embodiment 1

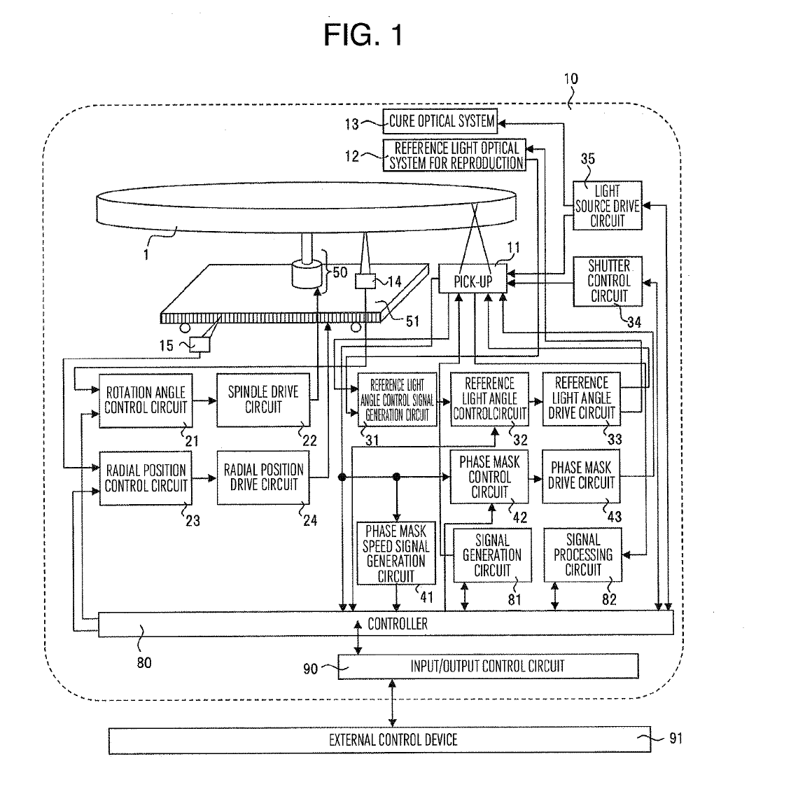

Embodiments of the present invention will be described in accordance with the attached drawings. FIG. 1 is a block diagram illustrating a storage/reproducing device of a holographic storage medium for storage and/or reproducing digital information by using holography.

A holographic storage/reproducing device 10 is connected to an external control device 91 via an input/output control circuit 90. When information is to be stored in a holographic storage medium 1, the holographic storage/reproducing device 10 receives an information signal to be stored from the external control device 91 by the input/output control circuit 90. When the information is to be reproduced from the holographic storage medium 1, the holographic storage/reproducing device 10 transmits the reproduced information signal by the input/output control circuit 90 to the external control device 91.

The holographic storage/reproducing device 10 includes a pick-up 11, a reference light optical system for reproduction 12, a cure optical system 13, a disc rotation angle detection sensor 14, a radial position detection sensor 15, a spindle motor 50, and a radial direction conveying unit 51.

The spindle motor 50 has a medium attaching/removing unit (not shown) capable of attaching/removing the holographic storage medium 1 with respect to its rotating shaft, and the holographic storage medium 1 is constituted rotatable by the spindle motor 50. At the same time, the holographic storage medium 1 is constituted movable in a radial direction by the radial direction conveying unit 51 on the basis of a position of the pick-up 11.

Positions where signal light and/or reference light is irradiated are determined by a position of the pick-up 11 which will be described later and are positions fixed to the device. In this embodiment, the spindle motor 50 and a movable unit and a moving stage of the radial direction conveying unit 51 function as means for changing the positions on the holographic storage medium 1 where the signal light and/or reference light is irradiated.

A rotation angle detection sensor 14 is used for detecting a rotation angle of the holographic storage medium 1. The rotation angle detection sensor 14 detects the rotation angle of the holographic storage medium 1 by using an angle detection mark provided on the holographic storage medium 1, for example. An output signal of the rotation angle detection sensor 14 is input into a rotation angle control circuit 21. When rotation angles at which the signal light and the reference light are irradiated are to be changed, the rotation angle control circuit 21 generates a drive signal on the basis of the output signal of the rotation angle detection sensor 14 and an instruction signal from a controller 80 and drives the spindle motor 50 through a spindle drive circuit 22. As a result, the rotation angle of the holographic storage medium 1 can be controlled.

Moreover, the radial position detection sensor 15 is used for detecting a position of the movable unit of the radial direction conveying unit 51. The radial position detection sensor 15 detects the position of the movable unit of the radial direction conveying unit 51 by using a position detection pattern to which a scale having a predetermined pattern is fixed, for example. An output signal of the radial position detection sensor 15 is input into a radial position control circuit 23. When the radial positions where the signal light and the reference light are irradiated are to be changed, the radial position control circuit 23 generates a drive signal on the basis of the output signal of the radial position detection sensor 15 and an instruction signal from the controller 80 and drives the radial direction conveying unit 51 through a radial position drive circuit 24. As a result, the holographic storage medium 1 is conveyed in the radial direction, and the radial positions where the signal light and the reference light are irradiated can be controlled.

The pick-up 11 plays a role of storing the digital information in the storage medium by using holography through irradiation of the reference light and the signal light to the holographic storage medium 1. At this time, the information signal to be stored is sent to a spatial light modulator which will be described later in the pick-up 11 through a signal generation circuit 81 by the controller 80, and the signal light is modulated by the spatial light modulator.

When the information stored in the holographic storage medium 1 is to be reproduced, a light wave for causing the reference light emitted from the pick-up 11 to be incident to the holographic storage medium 1 in a direction opposite to that during storage is generated in the reference light optical system for reproduction 12. The reproduced light reproduced by the reference light for reproduction is detected by a photodetector which will be described later in the pick-up 11, and the signal is reproduced by a signal processing circuit 82.

An angle of the reference light is controlled by generating a drive signal by a reference light angle control circuit 32 and by driving an actuator 220 which will be described later in the pick-up 11 and an actuator 223 which will be described later in the reference light optical system for reproduction 12 through a reference light angle drive circuit 33. In a reference light angle control signal generation circuit 31, a signal used for control of the reference light angle is generated from an output signal of at least either one of the pick-up 11 and the reference light optical system for reproduction 12. The reference light angle control circuit 32 executes control by using the output signal of the reference light angle control signal generation circuit 31 in accordance with an instruction from the controller 80.

A phase mask speed signal generation circuit 41 generates a speed signal of a phase mask on the basis of a phase mask position signal from a phase mask position detection sensor which will be described later in the pick-up 11.

A phase mask control circuit 42 generates a signal used for control of the phase mask on the basis of the phase mask position signal from a transfer mask position detection sensor which will be described later in the pick-up 11.

A position and a speed of the phase mask is controlled by a drive signal generated by the phase mask control circuit 42 in accordance of an instruction from the controller 80 on the basis of the position signal from the phase mask position detection sensor so as to drive an actuator 226 which will be described later in the pick-up 11 through a phase mask drive circuit 43.

The phase mask drive circuit 43 is for amplifying a voltage, for example, but this function may be included in the phase mask control circuit 42.

Irradiation time of the reference light and the signal light irradiated to the holographic storage medium 1 can be adjusted by controlling opening/closing time of a shutter in the pick-up 11 through a shutter control circuit 34 by the controller 80.

The cure optical system 13 plays a role of generating a light beam used for pre-cure and post-cure of the holographic storage medium 1. The pre-cure is a pre-process of irradiating a predetermined light beam in advance before the reference light and the signal light are irradiated to a desired position when the information is to be stored at a desired position in the holographic storage medium 1. The post-cure is a post-process of irradiating a predetermined light beam for disable additional storage at the desired position after the information is stored at the desired position in the holographic storage medium 1. The light beams used for the pre-cure and the post-cure preferably need to be incoherent light, that is, light with low coherence. The reference light and the like may be used for cure.

A predetermined light source drive current is supplied from a light source drive circuit 35 to light sources in the pick-up 11 and the cure optical system 13, and each light source can emit a light beam in a predetermined light amount.

Moreover, the pick-up 11 and the cure optical system 13 may be constituted such that several optical system constitutions or all the optical system constitutions are integrated and simplified.

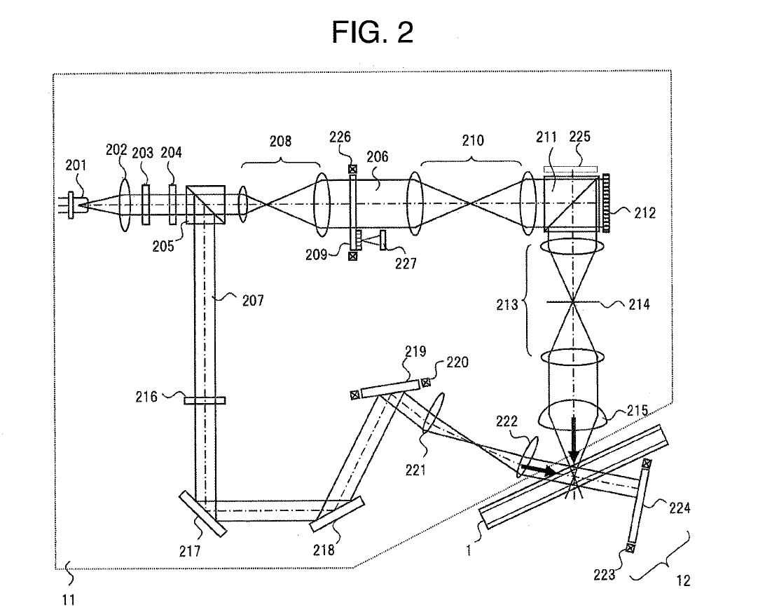

FIG. 2 illustrates a storage principle in an example of a basic optical system constitution of the pick-up 11 and the reference light optical system for reproduction 12 in the holographic storage/reproducing device 10. The reference light optical system for reproduction 12 is constituted by the actuator 223 and a galvanometer mirror 224.

The light beam emitted from a light source 201 is transmitted through a collimating lens 202 and incident to a shutter 203. When the shutter 203 is open, the light beam passes through the shutter 203 and then, has its polarization direction controlled by an optical element 204 constituted by a ½ wavelength plate or the like so that a light amount ratio between p-polarization and s-polarization becomes a desired ratio and then, is incident to a PBS (Polarization Beam Splitter) prism 205.

The light beam having transmitted through the PBS prism 205 works as signal light 206 and after a light beam diameter is enlarged by a beam expander 208, it is incident to a spatial light modulator 212 through a phase mask 209, a relay lens 210, and a PBS prism 211.

The signal light 206 is provided with phase information by passing through the phase mask 209. The phase mask 209 can be set to a desired position during storage by the actuator 226. A phase mask position detection sensor 227 is used for detecting a position of the phase mask 209. The phase mask position detection sensor 227 detects a position of the phase mask 209 with respect to a phase mask driving direction by using a position detection pattern to which a scale having a predetermined pattern is fixed, for example. An output signal of the phase-mask position detection sensor 227 is input to the phase mask speed signal generation circuit 41, the phase mask control circuit 42, and the controller 80.

The signal light provided with information by the spatial light modulator 212 is reflected by the PBS prism 211 and propagates through a relay lens 213 and a spatial filter 214. After that, the signal light is collected to the holographic storage medium 1 by an objective lens 215.

On the other hand, the light beam reflected by the PBS prism 205 works as reference light 207 and after its polarization direction is set to the predetermined direction by a polarization direction conversion element 216 depending on whether it is during storage or during reproduction, the light beam enters a galvanometer mirror 219 through a mirror 217 and a mirror 218. Since an angle of the galvanometer mirror 219 can be adjusted by the actuator 220, an incident angle of the reference light incident to the holographic storage medium 1 can be set to a desired angle after passing through a lens 221 and a lens 222. An element for converting a wave surface of the reference light may be used instead of the galvanometer mirror in order to set an incident angle of the reference light.

By causing the signal light and the reference light to enter the holographic storage medium 1 so as to overlap each other as above, an interference fringe pattern is formed in the storage medium, and by writing this pattern in the storage medium, the information is stored. Moreover, since the incident angle of the reference light incident to the holographic storage medium 1 can be changed by the galvanometer mirror 219, storage with angle multiplexing can be performed.

Hereinafter, in the hologram having been stored with the reference light angle changed in the same region, a hologram corresponding to each reference light angle is called a page, while a group of pages with angle multiplexing in the same region is called a book.

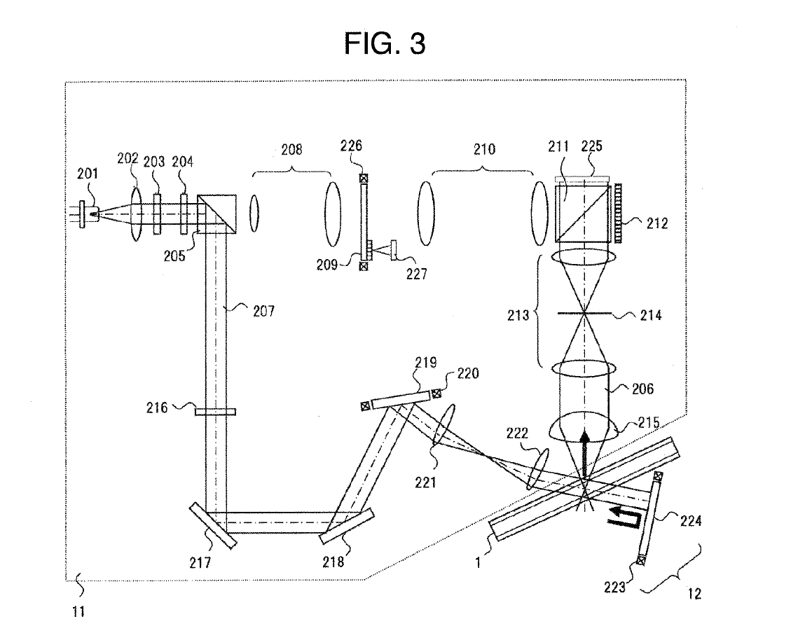

FIG. 3 illustrates a reproduction principle in an example of a basic optical system constitution of the pick-up 11 and the reference light optical system for reproduction 12 in the holographic storage/reproducing device 10. When the stored information is to be reproduced, the reference light is made to incident to the holographic storage medium 1 as described above, and the light beam having passed through the holographic storage medium 1 is reflected by the galvanometer mirror 24 whose angle can be adjusted by the actuator 223 so as to generate the reference light for reproduction.

The reproduced light reproduced by this reference light for reproduction propagates the objective lens 215, the relay lens 213, and the spatial filter 214. After that, the reproduced light is incident to a photodetector 225 via the PBS prism 211, and the stored signal can be reproduced. An image pickup element such as a CMOS image sensor and a CCD image sensor can be used as the photodetector 225, but it can be any element as long as the page data can be reproduced.

In this embodiment, the reference light angle control signal generation circuit 31 detects an angle of the reference light reflected by the galvanometer mirror 219 using an output signal of an angle detection sensor (not shown) provided in the actuator 220 as an input and generates a signal used for control of the reference light angle. Similarly, regarding the reference light optical system for reproduction 12, the reference light angle control signal generation circuit 31 detects an angle of the reference light reflected by the galvanometer mirror 224 using an output signal of the angle detection sensor (not shown) provided in the actuator 223 as an input and generates a signal used for control of the reference light angle. For the angle detection sensors provided in the actuator 220 and the actuator 223, an optical encoder can be used, for example.

In the storage technology using the principle of angle multiplexing of holography, a tolerance to a shift of the reference light angle tends to become extremely small. Thus, it may be so constituted that a mechanism for detecting a shift amount of the reference light angle is separately provided in the pick-up 11 without using the angle detection sensor provided in the actuator 220 and a reference light angle control signal generation circuit 85 generates a signal used for control of a reference light angle using an output signal of the mechanism as an input.

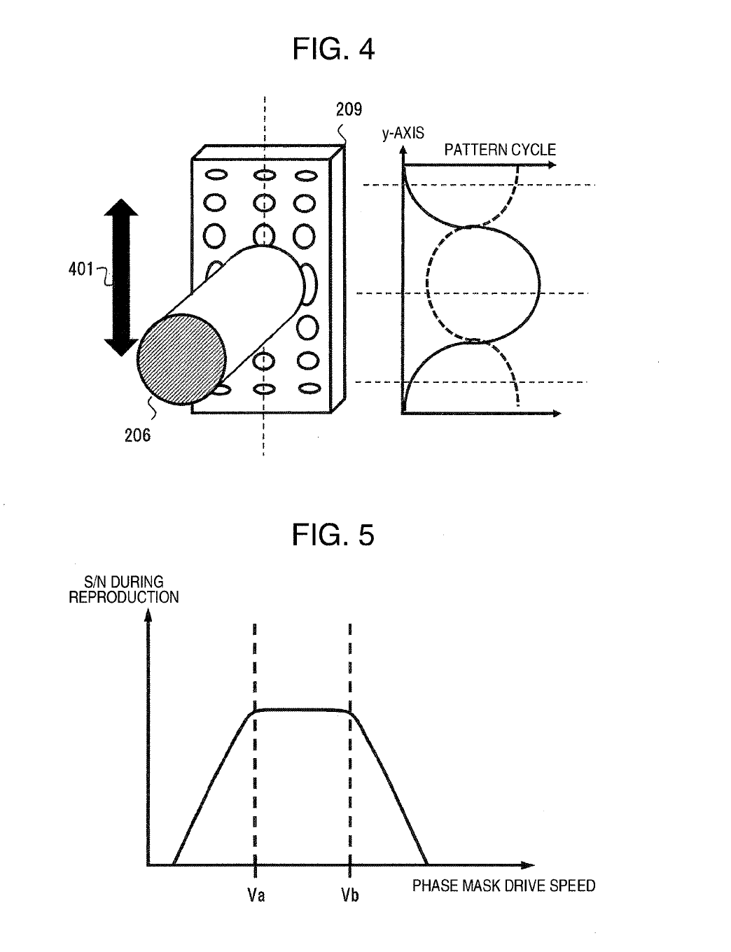

A shape of the phase mask 209 in this embodiment will be described. The phase mask 209 has a projection-and-recess shape as its sectional structure, for example, and is constituted to apply phase modulation to the incident light by a difference in optical-path lengths generated by the projections and recesses. A constitution example of the projection-and-recess shape is illustrated in FIG. 4. In the phase mask 209, projections and recesses which are sufficiently larger than a pixel pitch and sufficiently shallower (1% or less) than a wavelength are provided on a plane perpendicular to the signal light 206. These projections and recesses are formed with gentle edges as illustrated in FIG. 4 in order to make a change of the phase uniform. Assume that this phase mask is moved in a one-dimensional direction perpendicular to the signal light 206, that is, a direction indicated by 401 in FIG. 4. For simplification of the explanation, it is assumed that the projections and recesses on the surface of the phase mask are formed cyclically in the y-axis direction in FIG. 4.

When intensity is to be made uniform by driving the phase mask, a drive speed of the phase mask is preferably contained within an optimal drive speed range. This characteristic is illustrated in FIG. 5 as a schematic diagram of an SNR during reproduction with respect to the drive speed of the phase mask during storage. Here, the SNR is an index indicating a storage quality and it indicates that the larger its value is, the higher the storage quality is. At Va and Vb illustrated in FIG. 5 as borders, the slower the drive speed is than Va or the faster than Vb, the smaller the SNR becomes. On the other hand, if the drive speed is contained between Va and Vb, a substantially constant high SNR is obtained regardless of the drive speed. Values of the drive speeds Va and Vb are changed depending on exposure time during holographic storage and the like.

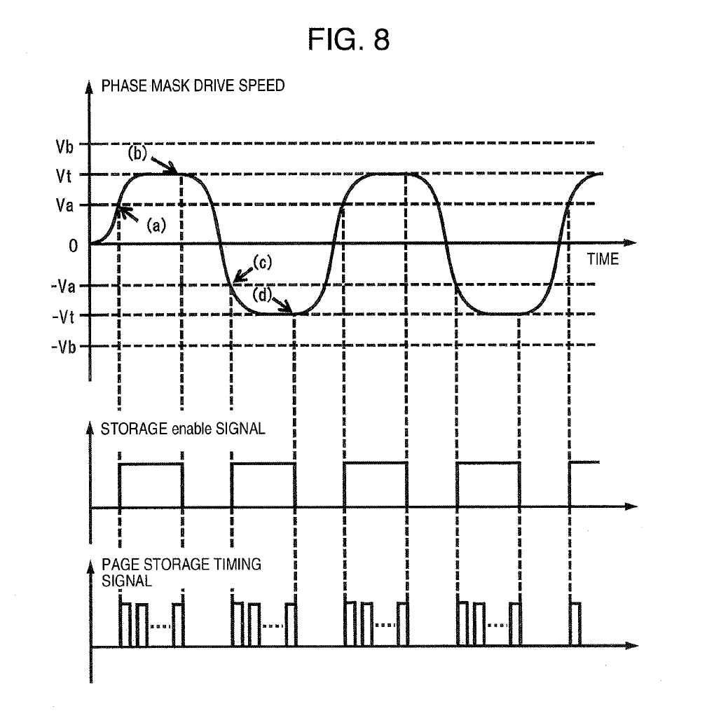

A control method of the drive speed of the phase mask considering the characteristic of the storage quality with respect to the drive speed of the phase mask as in FIG. 5 will be described by using FIG. 8.

FIG. 8 illustrates the phase mask drive speed, a storage enable signal, and a Page storage timing signal, respectively, using the lateral axis indicating elapsed time from start of storage processing.

Here, the storage enable signal is a signal determining availability of holographic storage for each continuous multi-storage unit, and if the enable signal is Low, it represents a storage prohibited state in the continuous multi-storage unit, while if the signal is High, it represents a storage allowed state in the continuous multi-storage unit, respectively. In order to associate it with physical availability of storage, if the storage enable signal is in the Low state, the shutter control circuit 34 closes the shutter in the pick-up 11 at all times and executes control such that laser irradiation cannot be performed. Similarly, it is assumed that the spatial light modulator 212 takes an unstorable state in which all the pixels are made Off pixels or an unstorable state by displaying a different random pixel pattern in a sufficiently short time cycle during which hologram formation is not possible in order to prevent burn-in of the spatial modulator.

Moreover, the Page storage timing signal is a signal determining availability of holographic storage in each page, and if the Page storage timing signal is Low, it represents the storage prohibited state of the page, while if the signal is High, it represents the storage allowed state in the page, respectively. A rising edge of the Page storage timing signal is conditional on a fact that the reference light angle positioning of the page has been finished and the storage enable signal is High. A falling edge of the Page storage timing signal is conditional on a fact that storage exposure time in the page has elapsed.

When the storage processing starts (0 time in FIG. 8), the phase mask starts acceleration. Since a high storage quality can be kept by performing storage while the drive speed of the phase mask is contained between Va and Vb, the drive speed of the phase mask is targeted to a drive speed Vt in the middle of Va and Vb, having the largest allowance with respect to a low speed side Va and a high speed side Vb.

At timing when the drive speed of the phase mask reaches Va (a point of time a in FIG. 8), the storage enable signal is made High. At the same time, the page storage timing signal on the first page of the continuous multi-storage unit becomes High. After the page storage timing signal continues to be High for the storage exposure time, it changes to Low. Subsequently, after positioning to the reference light angle on the next page is finished, the page storage timing signal becomes High again. After that, the page storage timing signal repeats changing between High and Low until storage of all the pages in the continuous multi-storage unit is finished. Then, at timing when the last storage exposure time of the continuous multi-storage unit is finished (a point of time b in FIG. 8), the storage enable signal changes to Low. From this timing, processing for storage of the subsequent continuous multi-storage unit is executed. In order to widely use a driving region of the phase mask driven in a one-dimensional direction in this embodiment, the driving direction of the phase mask is set to opposite to the driving direction so far. Thus, the phase mask starts deceleration with a speed −Vt as a target. Subsequently, at timing when the drive speed of the phase mask reaches −Va (a point of time c in FIG. 8), the storage enable signal is made High. At the same time, the page storage timing signal on the first page in the continuous multi-storage unit becomes High. After the page storage timing signal continues to be High for the storage exposure time, it changes to Low. Subsequently, after positioning to the reference light angle on the next page is finished, the page storage timing signal becomes High again. After that, the page storage timing signal repeats changing between High and Low until storage of all the pages in the continuous multi-storage unit is finished. Then, at timing when the storage exposure time of the last page of the last continuous multiple unit is finished (a point of time d in FIG. 8), the storage enable signal changes to Low.

In order to maintain the storage quality in storage, the phase mask needs to be continuously driven at the drive speed within the aforementioned optimal speed range during storage of the continuous multi-storage unit. On the other hand, the storage time required for storage of each continuous multi-storage unit is not necessarily constant. That is because it is likely that statically determinate time to the reference light angle of the target page in the page storage fluctuates due to an influence of disturbance or the like. In this case, considering the phase mask of this embodiment having a limited driving region with respect to the one-dimensional direction, there can be a problem that an end of the driving region of the phase mask is reached during storage of the continuous multi-storage unit, and the phase mask cannot be driven physically any more.

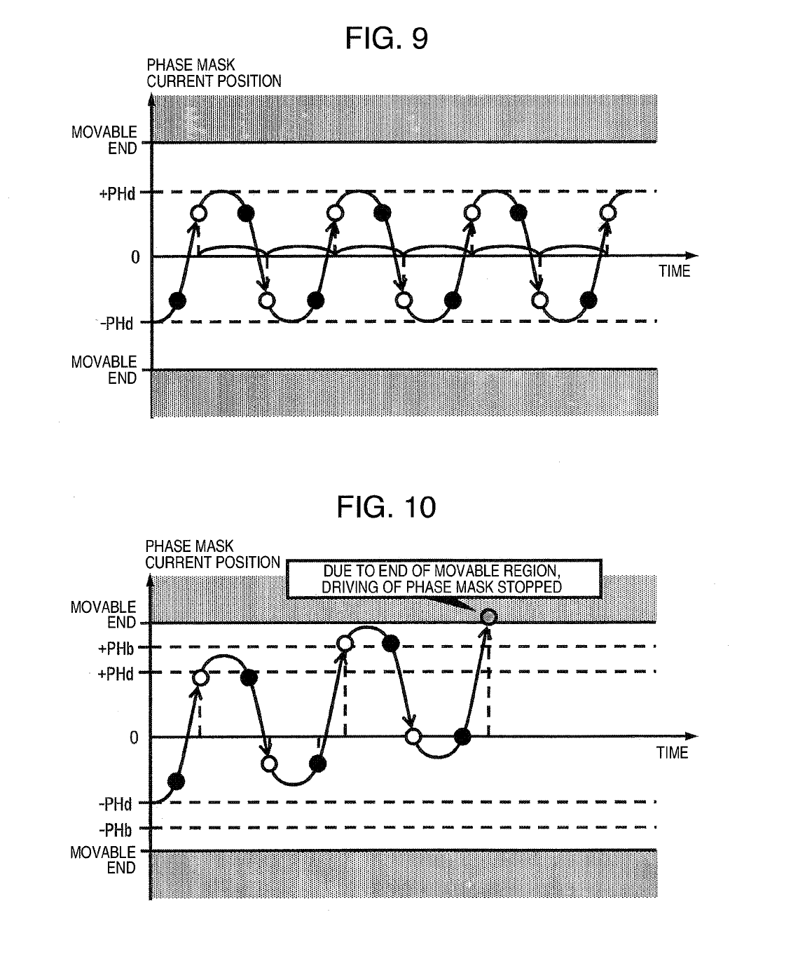

The aforementioned problem will be described by using FIGS. 9 and 10.

FIG. 9 schematically illustrates a state of driving of the phase mask during storage of the continuous multi-storage unit in an ideal state. The lateral axis indicates phase mask driving time, and the vertical axis indicates a position of the phase mask during driving, respectively. Black points in the figure indicate positions of the phase mask at timing of storage start on the first page in the continuous multi-storage unit, while white points indicate positions of the phase mask at timing when storage of the last page in the continuous multi-storage unit is finished. Here, a value of an absolute value PHd at a driving start position of the phase mask is acquired by the following equation by deriving PHIin which is a driving amount by which the phase mask is driven in the storage time required for storage of each continuous multi-storage unit and PHac which is a driving amount for driving until the drive speed Va is reached from the phase mask stop state as their average values by measurement of a plurality of holographic storage devices 10, respectively.

PHd=PHcon/2+PHac (equation 1)

In the ideal state, since the storage time required for storage of each continuous multi-storage unit is equal, the phase mask continues reciprocating between +PHd and −PHd as illustrated in FIG. 9.

On the other hand, FIG. 10 illustrates a case in which the storage time becomes longer only in the case of driving to an upper side in the figure. As a result, the reciprocating motion of the phase mask is gradually biased to the upper side and reaches an end of the movable region on the upper side during the continuous multi-storage in the end, and driving of the phase mask should be physically stopped. As a result, the phase mask driving time takes a value deviated from the optimal speed range, and the storage quality deteriorates. Moreover, in view of a contraction reaction of the holographic storage medium 1 after storage, standby time for contraction of the book is handled as unified time for the same book. Thus, if the storage is interrupted during storage of the same book, all the stored data of the book is made data not to be used, whereby a storage transfer speed and a storage capacity are lowered.

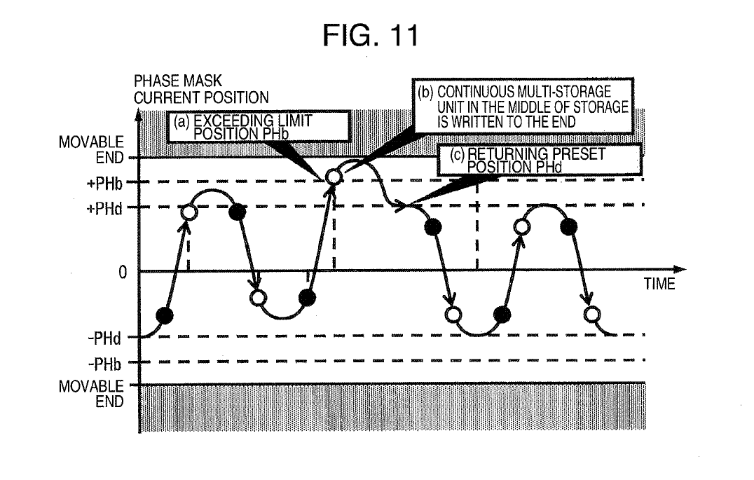

Regarding this problem, a solution by this embodiment will be described by using FIG. 11. FIG. 11 illustrates a case in which the storage time becomes longer only in the case of driving to the upper side in the figure similarly to FIG. 10. However, unlike FIG. 10, a current position PHc of the phase mask is monitored in this embodiment, and reaching the end of the movable region is prevented. In this embodiment, a position limit value PHb of the predetermined phase mask illustrated in FIG. 11 is provided. As illustrated in FIG. 11, if PHc exceeds PHb during storage of the continuous multiple-storage unit (a in FIG. 11), storage to the last page of the continuous multi-storage unit being currently stored is finished (b in FIG. 11). After that, by means of a sequence to return to a preset position PHd (c in FIG. 11), bias of the phase mask in the reciprocating driving is corrected. After returning to PHd, normal storage processing is continued. Here, the position limit value PHb of the phase mask is a parameter for optimization from a relation between a length of the movable region of the phase mask drive actuator 226 and time required for storage of the continuous multi-storage unit. For example, it is set to a value of 80% of a distance from a center of the movable region to the movable end of the phase mask.

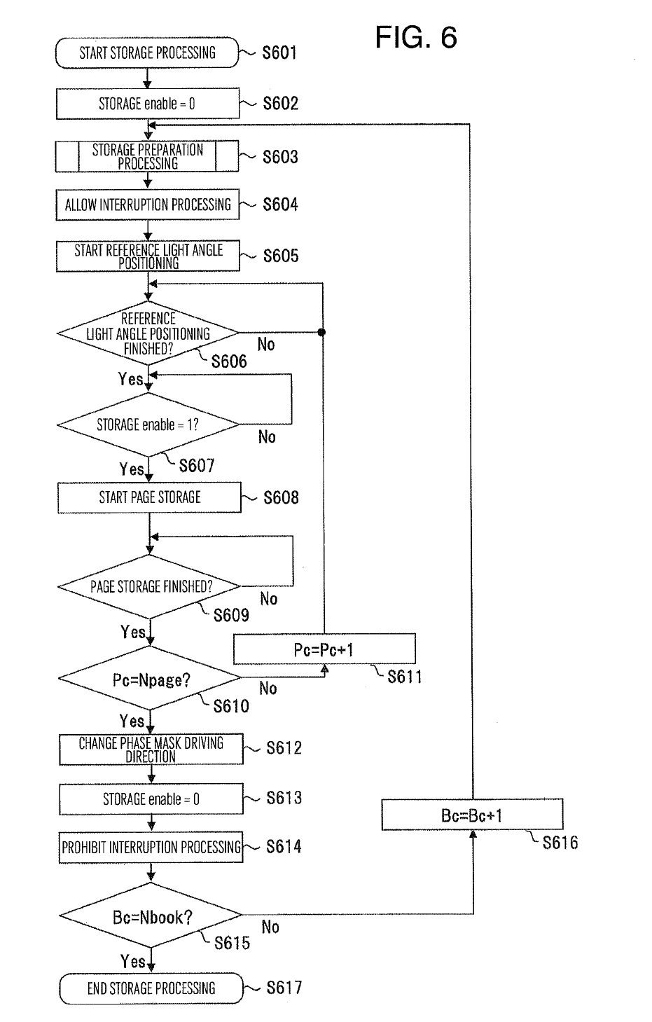

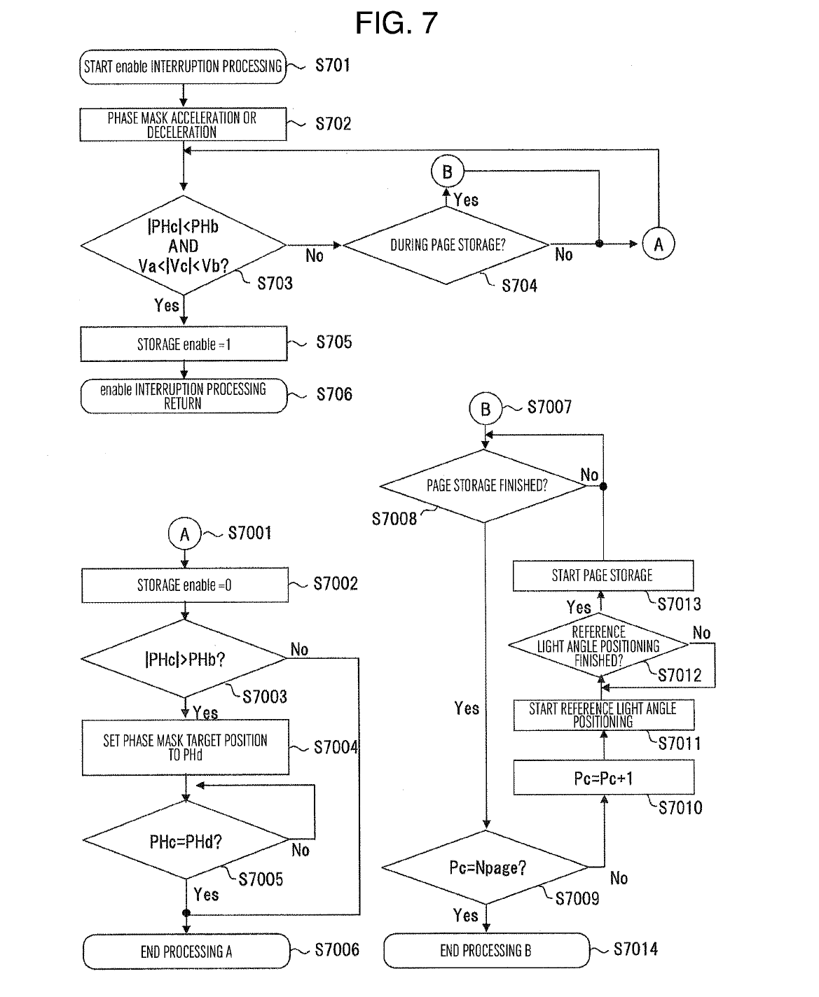

Moreover, a holographic storage sequence considering the characteristics of the storage quality to the drive speed of the phase mask in this embodiment will be described in detail by using a flowchart in FIG. 6 and FIG. 7. FIG. 6 illustrates the flowchart of the storage processing and FIG. 7 illustrates interruption processing in FIG. 6, respectively.

When the storage processing is started as illustrated in FIG. 6 (Step S601), the holographic storage/reproducing device 10 changes the storage enable signal to 0, that is, to Low (Step S602).

Subsequently, storage preparation processing is executed (Step S603). Here, the storage preparation processing at S603 means required processing in general except reference light angle positioning and phase mask driving in performing storage. For example, it includes processing such as a change of irradiation positions of the signal light and the reference light such as a radial position, a rotation angle, and an angle in an axis perpendicular to a reference light irradiation angle axis of the holographic storage medium 1, optimization of a wavelength and intensity of an irradiation laser, and pre-exposure of the holographic storage medium 1.

After the storage preparation processing is completed, interruption processing is allowed (Step S604). Details of the interruption processing will be described later.

After that, positioning of the reference light angle to an angle corresponding to Pc (a parameter indicating a current storage target page) which is a current storage target page is started (Step S605). Subsequently, it is determined whether or not page positioning has been finished (Step S606). The determination that the page positioning has been finished is made when a difference between the output signal of at least either one of the pick-up 11 and the reference light optical system for reproduction 12 and a target signal value corresponding to Pc is contained within a predetermined range. If the page positioning is not finished (No at S606), Step S606 is executed again, and Step S606 is repeated until the reference light angle positioning is finished. When it is determined that the page positioning is finished, the routine proceeds to Step S607.

At Step S607, it is determined whether or not the storage enable signal is 1, that is, it is High. The storage enable signal changes to High during the interruption processing which will be described later. If it is determined that the storage enable signal is not 1, that is, it is Low, Step S607 is executed again, and Step S607 is repeated until the storage enable signal becomes 1. When the storage enable signal becomes 1, the routine proceeds to Step S608.

At Step S608, the holographic storage is started in the page at the currently positioned reference light angle. Subsequently, at Step S609, it is determined whether or not the storage of the hologram in that page is finished. The determination that the holographic storage is finished in that page is made when the laser irradiation time has elapsed predetermined time. If the storage in that page is not finished (No at Step S609), Step S609 is executed again, and Step S609 is repeated until the storage in that page is finished. If it is determined that the storage is finished in that page at Step S609, the routine proceeds to Step S610.

At Step S610, it is determined whether or not Pc which is the page number of the page for which the storage is finished at Step S609 is a number of storage layers Npage which is a unit of the reference light multi-storage. For Npage in this embodiment, not the full storage layer number but a value obtained by dividing the full storage layer number for each predetermined storage layer number is used. Instead of performing the full multi-storage at once, by performing multi-storage after the division and change of the irradiation positions of the signal light and the reference light, consumption of the medium at an overlap portion between the signal light and the reference light which can occur if storage density is increased can be made uniform, and deformation of the holographic storage medium 1 and drop of the SNR during reproduction can be prevented. If Pc has not reached Npage (No at Step S610), the routine proceeds to Step S611. At Step S611, the value of Pc is increased only by 1, and the reference light target position is updated to the value of the next page. After Step S611 is finished, the routine proceeds to Step S606, and the sequence from Step S606 to Step S610 is repeated until Pc reaches Npage. When it is determined that Pc has reached Npage at Step S610, the routine proceeds to Step S612.

At Step S612, the driving direction of the phase mask is changed. That is, the phase mask is driven in a direction opposite to the direction in which the phase mask has been driven until Step S610. After Step S612 is finished, the routine proceeds to Step S613.

At Step S613, the storage enable signal is changed to 0, that is, to Low into a storage prohibited state. At Step S614 subsequent to Step S613, the interruption processing is prohibited.

Subsequently to Step S614, Step S615 is executed. At Step S615, it is determined whether or not a current book Bc (current storage target book) for which page storage has been finished at Step S610 is a last target book Nbook in this storage processing. If Bc has not reached Nbook (No at Step S615), the routine proceeds to Step S616. At Step S616, a value of Bc is increased only by 1, and the target book position is updated to the value of the next book. After Step S616 is finished, the routine proceeds to Step S603, and a sequence from Step S603 to Step S615 is repeated until Bc reaches Nbook. If it is determined at Step S615 that Bc has reached Nbook, the routine proceeds to Step S617, and the storage processing in this embodiment is finished.

Subsequently, the interruption processing in the storage processing in this embodiment will be described by using FIG. 7.

When the interruption processing is started as illustrated in FIG. 7 (Step S701), the holographic storage/reproducing device 10 accelerates or decelerates the phase mask (Step S702). Here, a polarity of a direction of the acceleration or deceleration of the phase mask is equal to the polarity determined in the sequence in FIG. 6. When Step S702 is finished, the routine proceeds to Step S703.

At Step S703, it is determined whether or not an absolute value of the current position PHc of the phase mask 209 is lower than PHb which is a predetermined limit value and an absolute value of a current drive speed Vc of the phase mask is larger than a predetermined lower limit value Va and smaller than a predetermined upper limit value Vb. Here, the current drive speed Vc of the phase mask is generated by the phase mask speed signal generation circuit 41 on the basis of a position signal from the phase-mask position detection sensor 227. For example, the drive speed Vc is calculated on the basis of each current position PHc in a predetermined sampling range.

The phase mask drive actuator 226 may be a stepping motor. In that case, a cumulative pulse number in predetermined time of the stepping motor is sent to the phase mask speed signal generation circuit 41, and the drive speed Vc of the phase mask may be generated on the basis of that value.

If it is determined to be No at Step S703, the routine proceeds to Step S704. At Step S704, it is determined whether or not it is during page storage. If it is not during the page storage (No at Step S704), the routine proceeds to processing A.

When the processing A is started (Step S7001), the storage enable signal is changed to 0, that is to Low into the storage prohibited state (Step S7002). After Step S7002 is finished, the routine proceeds to Step S7003.

At Step S7003, it is determined whether or not the absolute value of the current position PHc of the phase mask is lower than PHb which is the predetermined limit value. If it is determined to be No at Step S7003, the routine proceeds to Step S7006, and the processing A is finished.

If it is determined to be Yes at Step S7003, the routine proceeds to Step S7004. At Step S7004, the target position of the phase mask is set to the predetermined preset position PHd. After Step S7004 is finished, the routine proceeds to Step S7005. At Step S7005, it is determined whether or not the positioning of the phase mask to PHd which is the movement target position has been finished. The determination that the positioning of the phase mask has been finished is made when a difference between the position signal which is an output of the phase mask position detection sensor 227 and a target signal value corresponding o PHc is contained within a predetermined range, for example.

The phase mask drive actuator 226 may be a stepping motor. In that case, a cumulative pulse number of the stepping motor is sent instead of the position signal of the phase-mask position detection sensor 227, and the current position PHc of the phase mask may be generated on the basis of that value.

If it is determined to be No at Step S7005, the routine goes to Step S7005 again, and Step S7005 is repeated until positioning of the phase mask is finished. If it is determined to be Yes at Step S7005, the routine proceeds to Step S7006, and the processing A is finished. After the processing A is finished, then, the routine proceeds to Step S703.

If the determination at Step S704 is made to be Yes (Yes at Step S704), the routine proceeds to processing B.

When the processing B is started (Step S7007), it is determined whether or not the storage of the hologram in that page has been finished (Step S7008). If the storage in that page has not been finished (No at Step S7008), Step S7008 is executed again, and Step S7008 is repeated until the storage in that page is finished. If it is determined at Step S7008 that the storage in that page is finished, the routine proceeds to Step S7009. At Step S7009, it is determined whether or not Pc which is the page number of the page for which the storage is finished at Step S7008 is the storage layer number Npage which is a unit of the reference-light multi-storage.

If Pc has not reached Npage (No at Step S7009), the routine proceeds to Step S7010. At Step S7010, the value of Pc is increased only by 1, and the reference light target position is updated to the value of the next page. After Step S7010 is finished, the routine proceeds to Step S7011.

At Step S7011, positioning of the reference light angle to an angle corresponding to Pc which is the current storage target page is started. Subsequently, it is determined whether or not the page positioning is finished (Step S7012). If the page positioning is not finished (No at S7012), Step S7012 is executed again, and Step S7012 is repeated until the reference light angle positioning is finished. If it is determined that the page positioning is finished, the routine proceeds to Step S7013. At Step S7013, in the page at the currently positioned reference light angle, holographic storage is started. After Step S7013 is finished, the routine proceeds to Step S7008 again. A sequence from Step S7008 to Step S7013 is repeated until Pc reaches Npage at Step S7009. If it is determined at Step S7009 that Pc has reached Npage, the routine proceeds to Step S7014, and the processing B is finished. After the processing B is finished, the routine proceeds to the processing A.

If it is determined to be Yes at Step S703, the routine proceeds to Step S705. At Step S705, the storage enable signal changes to 1, that is, to High into the storage allowed state. After Step S705 is finished, the routine proceeds to Step S706, and the enable interruption processing in this embodiment is finished.

As described above, according to this embodiment, an increase in the number of storage layers by uniformization of medium consumption is realized, the storage quality of each pixel of the page interior and between pages is kept constant, and favorable and stable signal storage can be realized.

In this embodiment, the case in which the change of the drive speed of the phase mask is changed non-linearly as illustrated in FIG. 5 is exemplified, but the drive speed of the phase mask may be changed linearly.

Moreover, in this embodiment, the value obtained by dividing the full storage layer number for each predetermined storage layer number for Npage is used, but the full storage layer number may be used as they are for Npage.

Moreover, in this embodiment, the position limit value PHb of the phase mask is set to a value of 80% of the distance from the center of the movable region to the movable end of the phase mask, for example, but the value does not necessarily have to be used, and an optimal another value which does not lower a storage transfer speed may be used from a relation between a length of the movable region of the phase mask drive actuator 226 and time required for storage of the continuous multi-storage unit.

Moreover, in this embodiment, for the predetermined preset position PHd, a driving amount driven by the phase mask in average time of the storage time required for storage of each continuous multi-storage unit is derived from measurement and a half of it is set to the value, but due to the characteristic of the actuator 226, if bias to either one of movable directions can occur easily or the like, the value does not have to be the half and as the result of reciprocating driving of the phase mask, it may be a position where the largest allowance can be obtained until the end of the movable region is reached.

Moreover, in this embodiment, the projections and recesses of the phase mask are illustrated as fixed cycles for simplification of the description, but in order to make the phase of an incident light flux random, the projections and recesses on the phase mask surface can be arranged at random. In that case, the projection-and-recess cycle on the mask surface only needs to be formed so that a ratio between the drive speed of the phase mask crossing the incident light flux at an arbitrary position in the phase mask and a minimum value or an average value of the projection-and-recess interval on the mask surface becomes constant.

Moreover, in this embodiment, a method of adding the projections and recesses on the phase mask surface when the phase of a light flux 306 is changed is described, but as a method of changing the phase of the light flux, other than above, there is a method of embedding a material with a different refractive index in a flat plate such as a glass cyclically or at random or the like. The present application defines the relation between the drive speed of the phase mask crossing the incident light flux at the arbitrary position in the phase mask and the phase addition method of the mask surface, and does not limit a method of changing the phase of the light flux.

Moreover, if the storage enable signal cannot be generated unexpectedly by an abnormal operation of the phase-mask position detection sensor 227 or the like during the hologram storage and the end of the driving region of the phase mask drive actuator 226 is reached, processing of making the data of the book currently being stored handled as a defect, that is, to be handled as error data is executed. For example, an address of the data in the book determined to be a defect is held as system management information on the controller 80 side. Alternatively, after a system management region is prepared in the holographic storage medium 1, the data may be stored in the holographic storage medium 1.

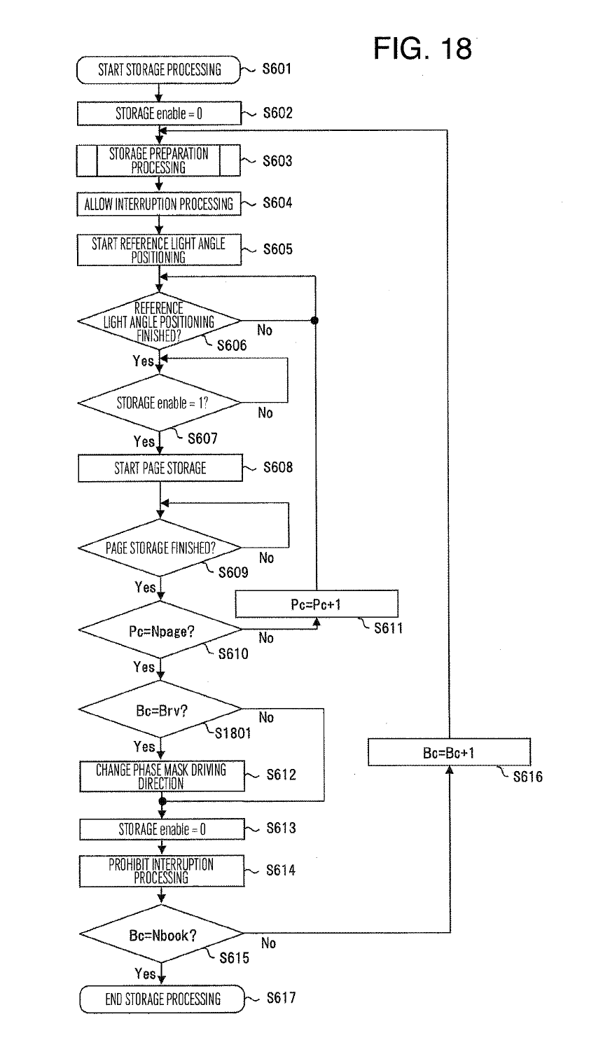

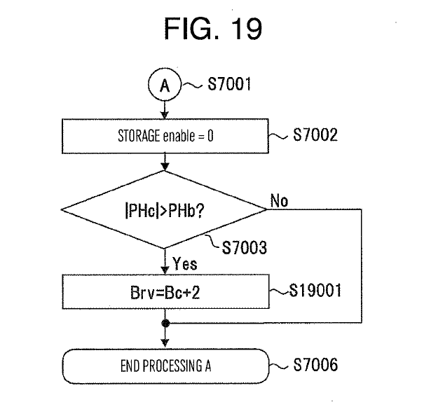

Moreover, in this embodiment, the driving direction of the phase mask is switched to the opposite direction for each continuous multi-storage unit, but depending on a width of the driving region of the phase mask drive actuator 226, the same driving direction may continue. For example, if it is determined that the position limit value PHb is reached, the driving to the opposite direction immediately after that may be continuously the same direction. A specific flow of this variation will be described by using FIGS. 18 and 19. Only Steps different from those in FIGS. 6 and 7 will be described below. At Steps with the same numbers, the same operations as those in the description in FIGS. 6 and 7 are performed.

If it is determined at Step S610 that Pc has reached Npage in FIG. 18, the routine proceeds to Step S1801. At Step 1801, it is determined whether the current book Bc is equal to a variable Brv for determining the phase-mask driving direction. If it is determined at Step S1801 that the current book Bc has reached Brv, the routine proceeds to Step S612, and the driving direction of the phase mask is changed. If the current book Bc has not reached Brv (No at Step S1801), the routine proceeds to Step S613.

If it is determined to be Yes at Step S7003 in FIG. 19, the routine proceeds to Step S19001. At Step S19001, Bc+2 obtained by adding only 2 to the current book Bc is substituted for the variable Brv for determining the phase mask driving direction and then, the routine proceeds to Step S7006, and the processing A is finished. If the current position of the phase mask is biased by the aforementioned processing to one side in the movable region, the phase mask is driven continuously in the same direction, and the bias of the position of the phase mask can be improved. In this embodiment, movement of the phase mask in the same direction is continuously twice, but the number of times may more than twice depending on a width of the driving region of the phase mask drive actuator 226, and it only needs to be so constituted that the phase mask is continuously driven in the same direction.

Moreover, at Step S1801, it may be so constituted that the driving direction of the phase mask is determined at Step S612 by determining whether or not the position of the phase mask is at on a + side or a − side from a reference position or within a reference range (a median point of the movable range of the phase mask or a predetermined range including the median point, for example). For example, if the position of the phase mask is on the + side from the reference position and the driving direction of the phase mask during storage is in the + direction, the driving direction of the phase mask is changed from the + direction to the − direction. If the position of the phase mask is on the − side from the reference position and the driving direction of the phase mask during storage is in the − direction, the driving direction of the phase mask is changed from the − direction to the + direction. If the position of the phase mask is on the + side from the reference position and the driving direction of the phase mask during storage is in the −direction, the driving direction of the phase mask is kept in the − direction and not changed. If the position of the phase mask is on the − side from the reference position and the driving direction of the phase mask during storage is in the + direction, the driving direction of the phase mask is kept in the + direction and not changed. In the case of this constitution, too, bias of the position of the phase mask can be improved.

Moreover, this embodiment is constituted in a holographic storage/reproduction in an angle multiplex method by interference of two light fluxes, but the phase mask driving method of this embodiment may be applied to a collinear method in which the signal light and the reference light are constituted by coaxial beams.

### Embodiment 2

In the embodiment 1, the phase mask 209 and the phase mask actuator 226 are constituted to have a reciprocating motion in a center region not reaching the movable end in the movable region in the one-dimensional direction (hereinafter the driving method in the embodiment 1 is called center reciprocating driving method).

The phase mask driven in the one-dimensional direction in this embodiment starts driving at one of the movable ends thereof and after storage of its continuous multi-storage unit is finished, it is driven to the other movable end. That is, it is a driving method of synchronizing storage of one continuous multi-storage unit with the driving of the phase mask (hereinafter the driving method in this embodiment is called a multi-storage unit synchronization method). For example, if the drive speed of the phase mask drive actuator 226 is faster than the speed of changing the irradiation positions of the signal light and the reference light, the multiple storage unit synchronization method can be applied without lowering the storage transfer speed.

By applying the multi-storage unit synchronization method, the whole driving region of the phase mask driving in the one-dimensional direction can be used for driving during storage. In the center reciprocating driving method, since only a part of the center portion in the whole driving region can be used for driving of the phase mask, it is likely that storage is stopped upon arrival at the movable end. In view of size reduction of the holographic storage device 10, size reduction of the phase mask drive actuator 226 is an indispensable requirement.

The size reduction of the phase mask drive actuator 226 is also reduction of the movable region at the same time and thus, the multi-storage unit synchronization method capable of using the whole driving region for driving during storage is advantageous for size reduction.

The embodiment of the present invention will be described below in accordance with the attached drawings. A basic optical constitution of the storage/reproducing device 10 of an optical information storage medium of this embodiment and the pick-up 11 is similar to those in FIGS. 1, 2 and 3, and the description will be omitted here.

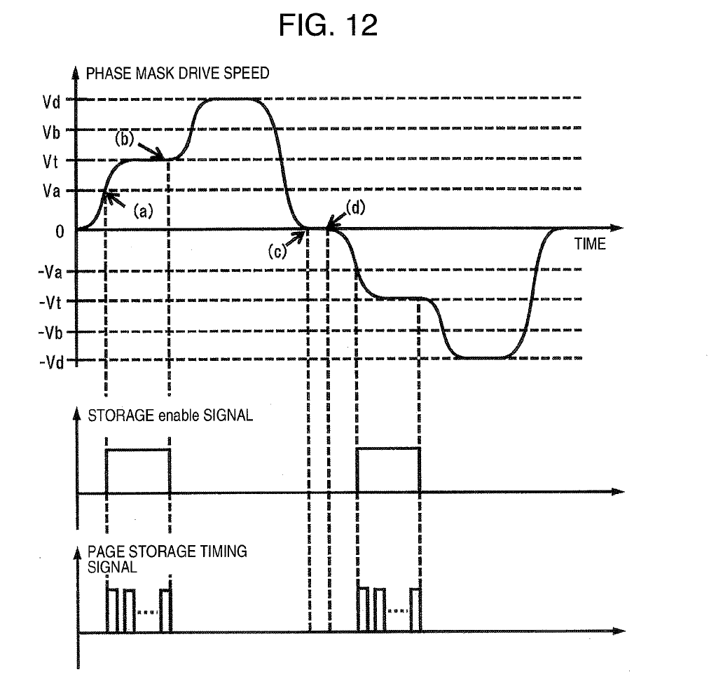

FIG. 12 illustrates the phase mask drive speed, the storage enable signal, and the Page storage timing signal when the multi-storage unit synchronization method is used by using elapsed time from start of storage processing as the lateral axis, respectively.

When the storage processing is started (0 time at FIG. 12), the phase mask starts acceleration. Similarly to the embodiment 1, the drive speed of the phase mask is targeted to a drive speed Vt in the middle of Va and Vb which has the largest allowance with respect to both the low speed side Va and the high speed side Vb.

At timing when the drive speed of the phase mask reaches Va (a point of time a in FIG. 12), the storage enable signal is made High. At the same time, the page storage timing signal on the first page of the continuous multi-storage unit becomes High. After the page storage timing signal continues to be High for the storage exposure time, it changes to Low. Subsequently, after positioning to the reference light angle on the next page is finished, the page storage timing signal becomes High again. After that, the page storage timing signal repeats changing between High and Low until storage of all the pages in the continuous multi-storage unit is finished. Then, at timing when the last storage exposure time of the continuous multiplex unit is finished (a point of time b in FIG. 12), the storage enable signal changes to Low.

In the center reciprocating driving method, driving of the phase mask in the opposite direction is started at this point of time, but in the multi-storage unit synchronization method, acceleration is started for driving to the movable end of the phase mask. At this time, since the storage has been finished, the drive speed which is a target of the acceleration is set to a drive speed Vd higher than Vb.

At timing when the movable end of the phase mask is reached (a point of time c in FIG. 12), and then, change of the irradiation positions of the signal light and the reference light has been finished (a point of time d in FIG. 12), storage of the continuous multi-storage unit for driving the phase mask in the direction opposite to the previous one is continued.

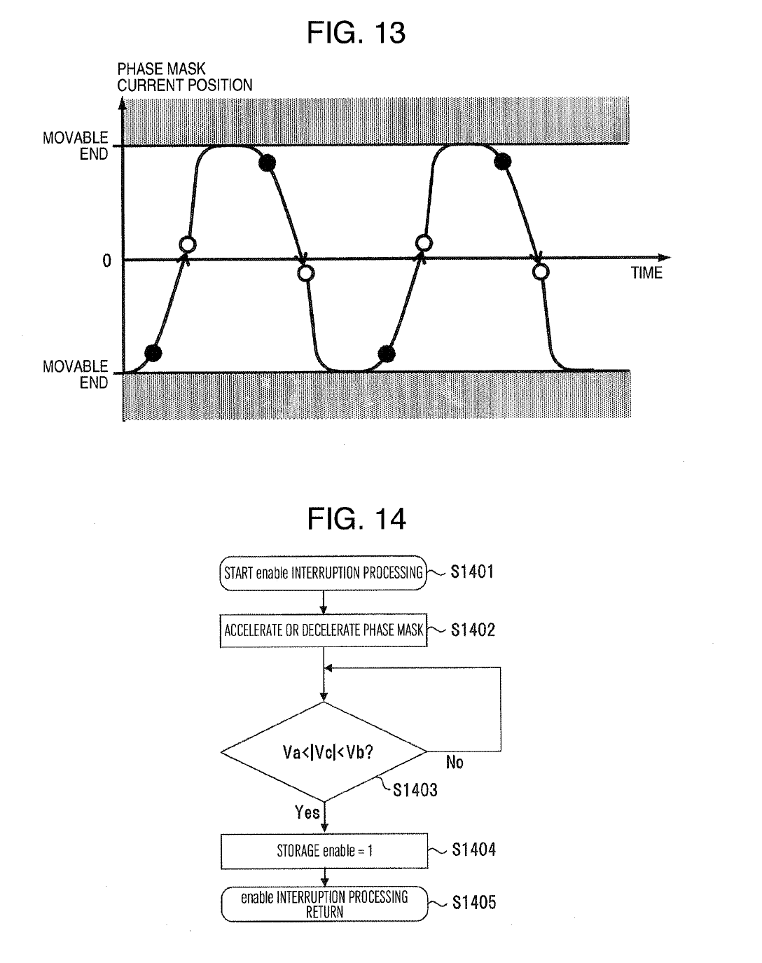

FIG. 13 schematically illustrates a state of driving of the phase mask in the multi-storage unit synchronization method in an ideal state. Black points in the figure indicate positions of the phase mask at timing of storage start on the first page in the continuous multi-storage unit, while white points indicate positions of the phase mask at timing when storage of the last page in the continuous multi-storage unit is finished, respectively. Since in the multiple unit synchronization method, the driving amount of the phase mask has a sufficient allowance as compared with the center reciprocating driving method, the phase mask 209 does not reach the movable end during the storage of the continuous multi-storage unit and there is no need to provide PHd or PHb in the center reciprocating driving method. FIG. 13 shows the ideal state in which the storage time of the continuous multiplex recording unit is substantially constant, but in the multiplex unit synchronization method, even if the storage time becomes longer due to disturbance or the like, the phase mask continues to reciprocate between the one movable end and the other movable end similarly to FIG. 13.

Moreover, a holographic storage sequence considering the characteristics of the storage quality to the drive speed of the phase mask in the multiplex unit synchronization method will be described by using a flowchart.

Since the main storage processing in the multiplex unit synchronization method is the flowchart illustrated in FIG. 6 which is the same as the one in the center reciprocating driving method, description for the main storage processing will be omitted here.

Subsequently, interruption processing during the storage processing in the multiplex unit synchronization method will be described by using FIG. 14.

When the interruption processing is started as illustrated in FIG. 14 (Step S1401), the holographic storage/reproducing device 10 accelerates or decelerates the phase mask (Step S1402). Here, the polarity of the direction of the acceleration or deceleration of the phase mask is equal to the polarity determined in the sequence in FIG. 6. When Step S1402 is finished, the routine proceeds to Step S1403.

At Step S1403, it is determined whether or not an absolute value of the current drive speed Vc of the phase mask is larger than a predetermined lower limit value Va and smaller than a predetermined upper limit value Vb. A generation method of Vc is assumed to be the same as that of the center reciprocating driving method. If it is determined to be No at Step S1403, the routine proceeds to Step S1403, and Step S1403 is repeated until it is determined to be Yes.

If it is determined to be Yes at Step S1403, the routine proceeds to Step 1404. At Step S1404, the storage enable signal changes to 1, that is, to High into the storage allowed state. After Step S1404 is finished, the routine proceeds to Step S1404, and the enable interruption processing in this embodiment is finished.

According to this embodiment as above, the whole driving region of the phase mask driven in the one-dimensional direction by the phase mask driving in the multi-storage unit synchronization method can be used for driving during the storage, and possibility that the movable end is reached and storage is stopped can be lowered as compared with the center reciprocating driving method in the embodiment 1.

### Embodiment 3

In the embodiment 1 and the embodiment 2, the constitution of the phase mask 209 and the phase mask drive actuator 226 is a reciprocating motion in the one-dimensional direction in the center region or the whole movable region.

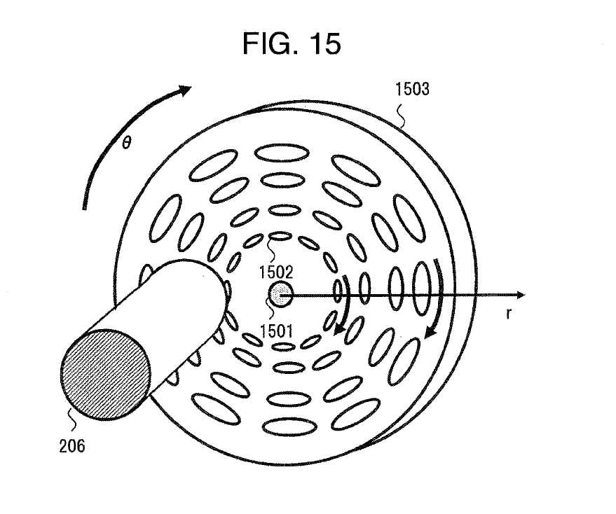

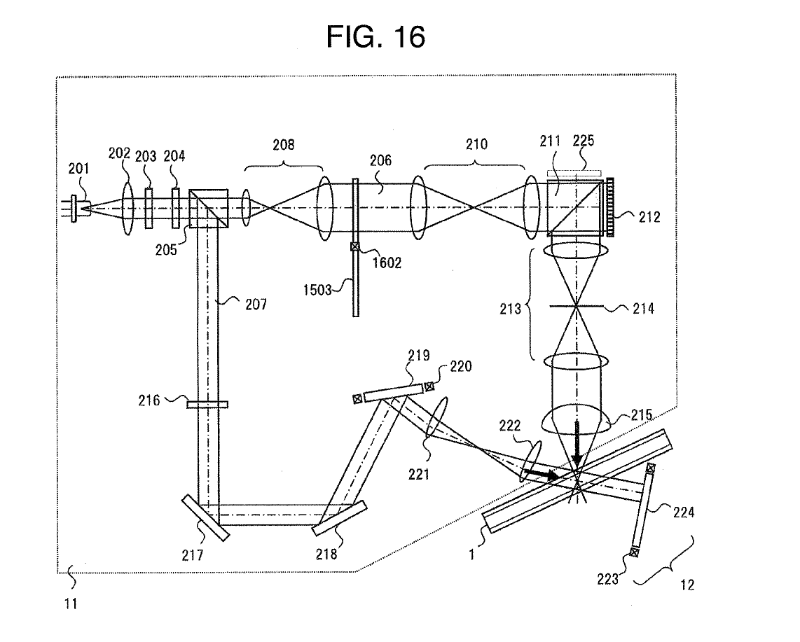

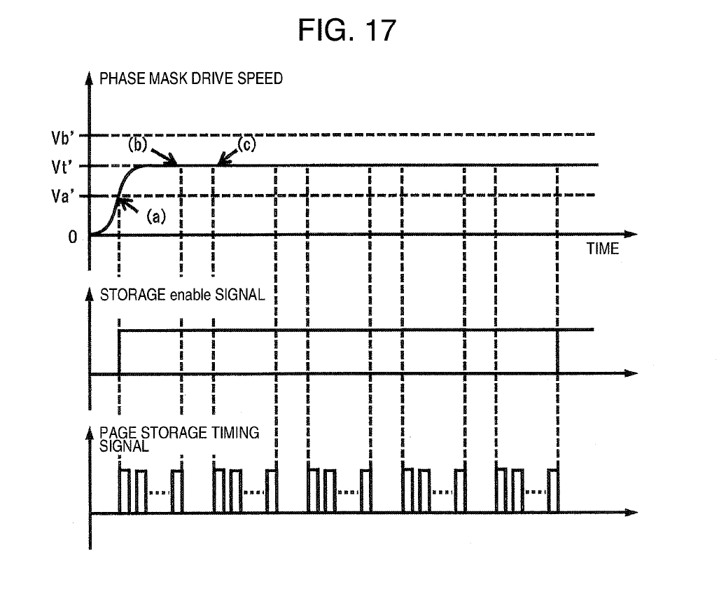

The phase mask in this embodiment is, unlike the embodiment 1 and the embodiment 2, a phase mask having a disc shape. FIG. 15 illustrates a phase mask in this embodiment and FIG. 16 illustrates the pick-up 11 in this embodiment, respectively. Similar reference numerals are given to elements having the functions similar to those in FIG. 2 in the embodiment 1 of the present invention, and the description will be omitted here. Reference numeral 1503 in the figure denotes a phase mask having a disc shape and is capable of rotation on a plane perpendicular to the light flux 206 around an axis 1501 by a phase mask drive actuator 1602. Here, the phase mask drive actuator 1602 has an optical position encoder (not shown) therein, which obtains position (angle) information of the phase mask 1503 and transmits it as a phase mask position signal to the phase mask control signal generation circuit 41.

In the phase mask 1503, projections and recesses which are sufficiently large with respect to a pixel pitch and sufficiently shallow (1% or less) with respect to a wavelength are assumed to be arranged on the phase mask surface cyclically in a circumferential direction similarly to the phase mask 209 in the first embodiment. Moreover, the surface projections and recesses of the phase mask are assumed to have a cyclic pattern in the rotation circumferential direction at each radial position.

In the phase mask having the disc shape as above, a linear velocity is different depending on the radial position. On the other hand, in order to make a storage condition of each pixel of a page interior and between pages uniform when the phase mask is driven, a speed of a phase change of the page interior and between the pages of the light flux 206 is preferably constant or constant or more. Thus, when the phase mask is to be rotated/driven, the projection-and-recess cycle on the mask surface is formed so that a ratio between the linear velocity crossing the incident light flux at an arbitrary radial position of the phase mask and the projection-and-recess cycle on the mask surface at the radial position becomes constant. As a result, the speed of the phase change of the page interior and between the pages of the light flux 206 during information storage in the medium can be made constant.

As described above, in the case in which the disc-shaped phase mask 1503 is used, the increase in the number of storage layers by uniformization of medium consumption in the angle multiple storage is realized, the storage condition of each pixel of the page interior and between the pages can be made equal, and stable storage performance can be ensured.

The basic optical system of the storage/reproducing device 10 of the optical information storage medium of this embodiment is similar to that in FIG. 1, and the description will be omitted here.

FIG. 17 illustrates the phase mask drive speed, a storage enable signal, and a Page storage timing signal in this embodiment, respectively, using the lateral axis indicating elapsed time from start of storage processing.

When the storage processing is started (0 time in FIG. 17), the phase mask starts acceleration. Phase mask drive speeds Va′, Vb′, and Vt′ in this figure represent values obtained by converting Va, Vb, and Vt in the embodiment 1 and the embodiment 2 to drive speeds in the circumferential direction, respectively. The drive speed of the phase mask is targeted to the drive speed Vt′ in the middle of Va′ and Vb′, having the largest allowance with respect to both of a low speed side Va′ and a high speed side Vb′.

At timing when the drive speed of the phase mask reaches Va′ (a point of time a in FIG. 17), the storage enable signal is made High. At the same time, the page storage timing signal on the first page of the continuous multi-storage unit becomes High. After the page storage timing signal continues to be High for the storage exposure time, it changes to Low. Subsequently, after positioning to the reference light angle on the next page is finished, the page storage timing signal becomes High again. After that, the page storage timing signal repeats changing between High and Low until storage of all the pages in the continuous multi-storage unit is finished. Unlike in the embodiment 1 and embodiment 2, in this embodiment, the storage enable signal remains High even at timing when the last storage exposure time of the continuous multiplex unit is finished (a point of time b in FIG. 17). Subsequently, after the positioning of the signal light and the reference light to the subsequent continuous multi-storage unit is finished (a point of time c in FIG. 17), the page storage timing signal becomes High and then, at timing when the storage exposure time of the last page of the last continuous multiplex unit is finished, the storage enable signal changes to Low.

Since the main storage processing and the interruption processing during the storage processing in this embodiment have the flowcharts illustrated in FIG. 6 in the embodiment 2, respectively, the description is omitted here.

According to this embodiment above, the increase of the storage layer number by uniformization of the medium consumption can be realized while using the phase mask having the disc shape, the storage quality of each pixel of the page interior and between the pages is kept constant, and the favorable and stable signal storage can be realized.

In this embodiment, the position signal of the phase mask 1503 is obtained by an optical position encoder provided in the phase mask drive actuator 1602, but the phase mask drive actuator 1602 may be a stepping motor. In that case, a cumulative pulse number of the stepping motor is sent as a position signal to the phase mask speed signal generation circuit 41, the phase mask control circuit 42, and the controller 80, and a drive speed Vc′ of the phase mask may be generated on the basis of a value of the cumulative pulse at a predetermined time interval.

The present invention is not limited to the aforementioned embodiments but includes various variations. For example, the aforementioned embodiments are described in detail in order to explain the present invention to be understood easily and are not necessarily limited to those including all the described constitutions. Moreover, a part of the constitution of one embodiment can be replaced by the constitution of another embodiment, and the constitution of one embodiment can be added to the constitution of another embodiment. Moreover, regarding a part of the constitution of each embodiment, another constitution can be added/deleted/replaced.

Moreover, a part of or the whole of each of the constitution, function, processing unit, processing means and the like above may be realized by hardware through design of an integrated circuit or the like. Moreover, each of the constitution, function and the like above may be realized by software by interpretation and execution of programs realized by a processor of the respective functions. Information such as a program, a table, a file and the like for realizing each function can be placed in a storage device such as a memory, a hard disk, an SSD (Solid State Drive) and the like or a storage medium such as an IC card, an SD card, a DVD and the like.

Moreover, the figures illustrate the control line and the information line considered to be required for explanation and do not necessarily illustrate all the control lines and information lines on a product. It may be so considered that almost all the constitutions are mutually connected in actuality.

### REFERENCE SIGNS LIST

1 holographic storage medium
10 holographic storage/reproducing device
11 pick-up
12 reference light optical system for reproduction
13 disc Cure optical system
14 disc rotation angle detection optical system
15 radial position detection sensor
21 rotation angle control circuit
22 spindle drive circuit
23 radial position control circuit
24 radial position drive circuit
31 reference light angle control signal generation circuit
32 reference light angle control circuit
33 reference light angle drive circuit
34 shutter control circuit
35 light source drive circuit
41 phase mask speed signal generation circuit
42 phase mask control circuit
43 phase mask drive circuit
80 controller
81 signal generation circuit
82 signal processing circuit
90 input/output control circuit
91 external control device
203 shutter
209 phase mask
226 phase mask drive actuator
227 phase mask position detection sensor
1503 phase mask
1602 phase mask drive actuator

1. A holographic storage device for storing information by irradiating signal light and reference light to a holographic storage medium, comprising:
a phase mask that adds phase information to the signal light;
a phase mask drive unit that drives the phase mask;
a phase mask control unit that controls the phase mask drive unit; and
a phase mask drive speed detection unit that detects a drive speed of the phase mask, wherein
when the phase mask drive speed obtained by the phase mask drive speed detection unit is contained within a predetermined range, storage of the information is executed.

2. The holographic storage device according to claim 1, further comprising:
a shutter that irradiates or shuts off either one or both of the signal light and the reference light;
a shutter drive unit that drives the shutter; and
a shutter control unit that controls the shutter drive unit, wherein
when the phase mask drive speed obtained by the phase mask drive speed detection unit is contained within a predetermined range, the shutter control unit controls the shutter drive unit so as to irradiate the signal light and the reference light, and the storage of the information is executed.

3. The holographic storage device according to claim 1, further comprising:
a spatial light modulator that adds two-dimensional phase information to the signal light, wherein
when the phase mask drive speed obtained by the phase mask drive speed detection unit is outside a predetermined range, the spatial light modulator causes a random pixel pattern different in a predetermined time cycle in hologram formation to be displayed so that storage of a hologram is not to be executed.

4. The holographic storage device according to claim 1, wherein
the phase mask drive unit rotates/moves the phase mask around an axis in parallel with an optical axis of the signal light.

5. The holographic storage device according to claim 1, wherein
storage of information is executed for each predetermined storage unit, and storage of information is executed so that a position of the phase mask obtained by the phase mask position detection unit does not reach a movable end of the phase mask drive unit during storage of the storage unit.

6. The holographic storage device according to claim 5, further comprising:
an irradiation position change unit that changes irradiation positions on the holographic storage medium of the signal light and the reference light, wherein
the storage unit is a storage unit executed by the irradiation position change unit without changing the irradiation position.

7. The holographic storage device according to claim 5, further comprising:
an irradiation position change unit that changes irradiation positions on the holographic storage medium of the signal light and the reference light; and
a reference light angle change unit that changes an incident angle of the reference light, wherein
the storage unit is a storage unit executed by the irradiation position change unit without changing the irradiation position and for which the reference light angle change unit scans the incident angle of the reference light by a predetermined amount.

8. The holographic storage device according to claim 5, wherein
the storage unit is a book unit.

9. The holographic storage device according to claim 5, wherein
a driving direction of the phase mask is switched in accordance with a position of the phase mask obtained by the phase mask position detection unit when storage of the predetermined storage unit is finished.

10. The holographic storage device according to claim 1, wherein
the information storage is executed for each predetermined storage unit, and at start of the storage of the storage unit, driving is started from one movable end of the phase mask drive unit and movement is performed to the other movable end of the phase mask after the storage of the storage unit is finished.

11. The holographic storage device according to claim 10, further comprising:
an irradiation position change unit that changes irradiation positions on the holographic storage medium of the signal light and the reference light, wherein
the storage unit is a storage unit executed by the irradiation position change unit without changing the irradiation position.

12. The holographic storage device according to claim 10, further comprising:
an irradiation position change unit that changes irradiation positions on the holographic storage medium of the signal light and the reference light; and
a reference light angle change unit that changes an incident angle of the reference light, wherein
the storage unit is a storage unit executed by the irradiation position change unit without changing the irradiation position and for which the reference light angle change unit scans the incident angle of the reference light by a predetermined amount.

13. A holographic storage device for storing information by irradiating signal light and reference light to a holographic storage medium, comprising:
a phase mask that adds phase information to the signal light;
a phase mask drive unit that drives the phase mask in a one-dimensional direction;
a phase mask control unit that controls the phase mask drive unit; and
a phase mask position detection unit that detects a position of the phase mask, wherein
information storage is executed for each predetermined storage unit, and during storage of the storage unit, the information storage is executed so that the position of the phase mask obtained by the phase mask position detection unit does not reach a movable end of the phase mask drive unit.

14. A holographic storage device for storing information by irradiating signal light and reference light to a holographic storage medium, comprising:
a phase mask that adds phase information to the signal light;
a phase mask drive unit that drives the phase mask in a one-dimensional direction; and
a phase mask control unit that generates the phase mask drive signal, wherein
the information storage is executed for each predetermined storage unit, and at start of the storage of the storage unit, driving is started from one movable end of the phase mask drive unit and movement is performed to the other movable end of the phase mask after the storage of the storage unit is finished.

15. A holographic storage device for storing information by irradiating signal light and reference light to a holographic storage medium, comprising:
a phase mask that adds phase information to the signal light;
a phase mask drive unit that drives the phase mask in a one-dimensional direction;
a phase mask control unit that controls the phase mask drive unit; and
a phase mask position detection unit that detects a position of the phase mask, wherein
the information storage is executed for each predetermined storage unit, and when storage of the predetermined storage unit is finished, in accordance with a position of the phase mask obtained by the phase mask position detection unit, the phase mask control unit controls a driving direction of the phase mask.
